(19) United States
(12) Patent Application Publication
(10) Pub. No.: US 2026/0161914 A1
(43) Pub. Date: Jun. 11, 2026

(54) COLOR ADJUSTMENT MANAGEMENT METHOD, COLOR ADJUSTMENT MANAGEMENT APPARATUS, AND STORAGE MEDIUM

(71) Applicant: Konica Minolta, Inc., Tokyo (JP)

(72) Inventors: Masatsugu KOUGUCHI, Tokyo (JP); Kazuma MARUYAMA, Tokyo (JP)

(21) Appl. No.: 19/361,520

(22) Filed: Oct. 17, 2025

(30) Foreign Application Priority Data
Oct. 23, 2024 (JP) 2024-186279

(51) Int. Cl. G06K 15/02

(52) U.S. Cl. CPC G06K 15/1878; G06K 15/027; G06K 15/1882; G06K 2215/0094

(57) ABSTRACT

A color adjustment management method of managing color adjustment of a first image forming engine capable of forming an image with, in addition to color materials of four colors of cyan, magenta, yellow and black, a color material of a fifth color different from the color materials of the four colors includes receiving a selection of a color adjustment setting in which a first color material setting indicating whether to use the color material of the fifth color for image formation and a sheet attribute setting of a sheet to be used for image formation are associated with each other; and causing the first image forming engine to perform color adjustment based on the first color material setting and the sheet attribute setting corresponding to the selected color adjustment setting.

### CROSS-REFERENCE TO RELATED APPLICATION

The entire disclosure of Japanese Patent Application No. 2024-186279, filed on October 23, 2024, including description, claims, drawings and abstract is incorporated herein by reference.

### BACKGROUND OF THE INVENTION

### TECHNICAL FIELD

The present disclosure relates to a color adjustment management method, a color adjustment management apparatus, and a storage medium.

### DESCRIPTION OF RELATED ART

In general, an image forming apparatus forms an image using four color materials of cyan, magenta, yellow, and black. Examples of the color materials include toner and ink. Hereinafter, the four colors of cyan, magenta, yellow, and black may be simply referred to as “CMYK four colors”. There is also an image forming apparatus that forms an image using a fifth color material other than CMYK four colors with the aim of making a printed material more attractive. For example, an image forming apparatus that uses a white color material as the fifth color material can form an image on a black sheet or the like by placing the color materials of CMYK four colors on the white color material.

Meanwhile, with the progress of the technology related to image formation, The level requested by clients (customers) related to QCD of printed materials is increased. Regarding the quality (Q), not only the use of the color materials of CMYK four colors and the fifth color material but also higher color reproducibility has been demanded. In addition, regarding the cost (C) and the delivery (D), reduction in labor cost and quick delivery are demanded.

For an image processing apparatus that corrects process colors (CMYK) and spot colors, a technology has been proposed in which designation of a correction target color is received, and a gradation correction pattern to be formed on a recording medium is specified based on the designation (see Japanese Unexamined Patent Publication No. 2021-15272). The image processing apparatus forms the specified gradation correction pattern on a recording medium and corrects the correction target color on the basis of the result of color measurement of the gradation correction pattern. In the technology disclosed in Japanese Unexamined Patent Publication No. 2021-15272, the processing time for correction is shortened by narrowing down correction target colors.

### SUMMARY OF THE INVENTION

Color adjustment is one of tasks for enhancing color reproducibility in an image forming apparatus. The color adjustment in the image forming apparatus (five color machine) using color materials of CMYK four colors and the fifth color material has more elements to be considered than the color adjustment in the image forming apparatus (four color machine) using color materials of CMYK four colors. For this reason, when an inexperienced operator performs color adjustment in the five color machine, the request of the client regarding the QCD cannot be satisfied.

The present disclosure has been made in view of the above-described problems in the conventional technology, and an object of the present disclosure is to provide execution of color adjustment that does not require a high level of skill for an operator who has little experience in color adjustment.

To achieve at least one of the abovementioned objects, according to an aspect of the present disclosure, a color adjustment management method reflecting one aspect of the present disclosure is a color adjustment management method of managing color adjustment of a first image forming engine capable of forming an image with, in addition to color materials of four colors of cyan, magenta, yellow and black, a color material of a fifth color different from the color materials of the four colors, the color adjustment management method including:

receiving a selection of a color adjustment setting in which a first color material setting indicating whether to use the color material of the fifth color for image formation and a sheet attribute setting of a sheet to be used for image formation are associated with each other; and

causing the first image forming engine to perform color adjustment based on the first color material setting and the sheet attribute setting corresponding to the selected color adjustment setting.

includes:

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a configuration diagram of a color management system in an embodiment of an embodiment of the present disclosure;

FIG. 2 is a block diagram illustrating a configuration of a printer;

FIG. 3 is a diagram illustrating examples of correction values held in the printer;

FIG. 4 is a view for explaining a printing mode;

FIG. 5 is a diagram showing a relationship between toner to be used and a sheet color to be used in each printing mode;

FIG. 6 is a block diagram illustrating a configuration of a PC;

FIG. 7 is a diagram illustrating examples of data structures of a printer table, an adjustment condition table, and a color management preset table;

FIG. 8 is a ladder chart which shows an outline of a color adjustment process;

FIG. 9 is a flowchart illustrating a color management preset registration process;

FIG. 10 is an example of a color management preset setting screen;

FIG. 11 is an example of a sheet-and-print setting screen;

FIG. 12 is an example of a color management preset list screen;

FIG. 13 is a flowchart illustrating a color adjustment time process;

FIG. 14 is an example of a color management preset selection screen;

FIG. 15 is an example of an adjustment target color selection screen;

FIG. 16 is an example of a chart used for color adjustment;

FIG. 17 is an example of a chart printing screen;

FIG. 18 is an example of an adjustment result screen of calibration in a CMYK printing mode and a white undercoat printing mode; and

FIG. 19 is an example of a calibration adjustment result screen in the white printing mode.

### DETAILED DESCRIPTION

Hereinafter, one or more embodiments of the present disclosure will be described with reference to the drawings. The advantages and features provided by the embodiments will be understood from the following detailed description and the drawings. However, the scope of the present disclosure is not limited to the embodiments disclosed below or examples illustrated in the drawings.

### Configuration of Color Management System

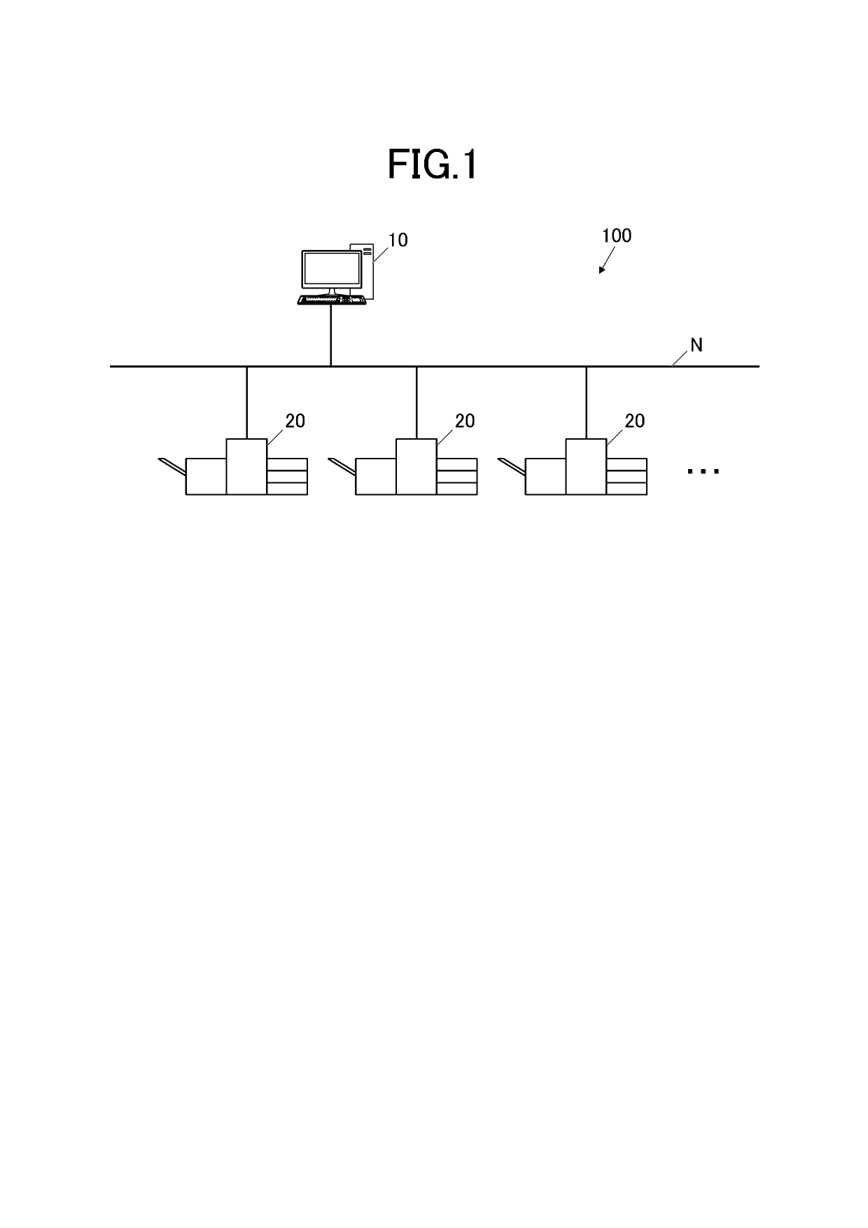

FIG. 1 illustrates a configuration of a color management system 100 according to the present embodiment. The color management system 100 includes a personal computer (PC) 10 as a color adjustment management apparatus, and a plurality of printer 20.

The PC 10 and the plurality of printers 20 are connected via a communication network N such as a local area network (LAN) so as to be able to perform data communication.

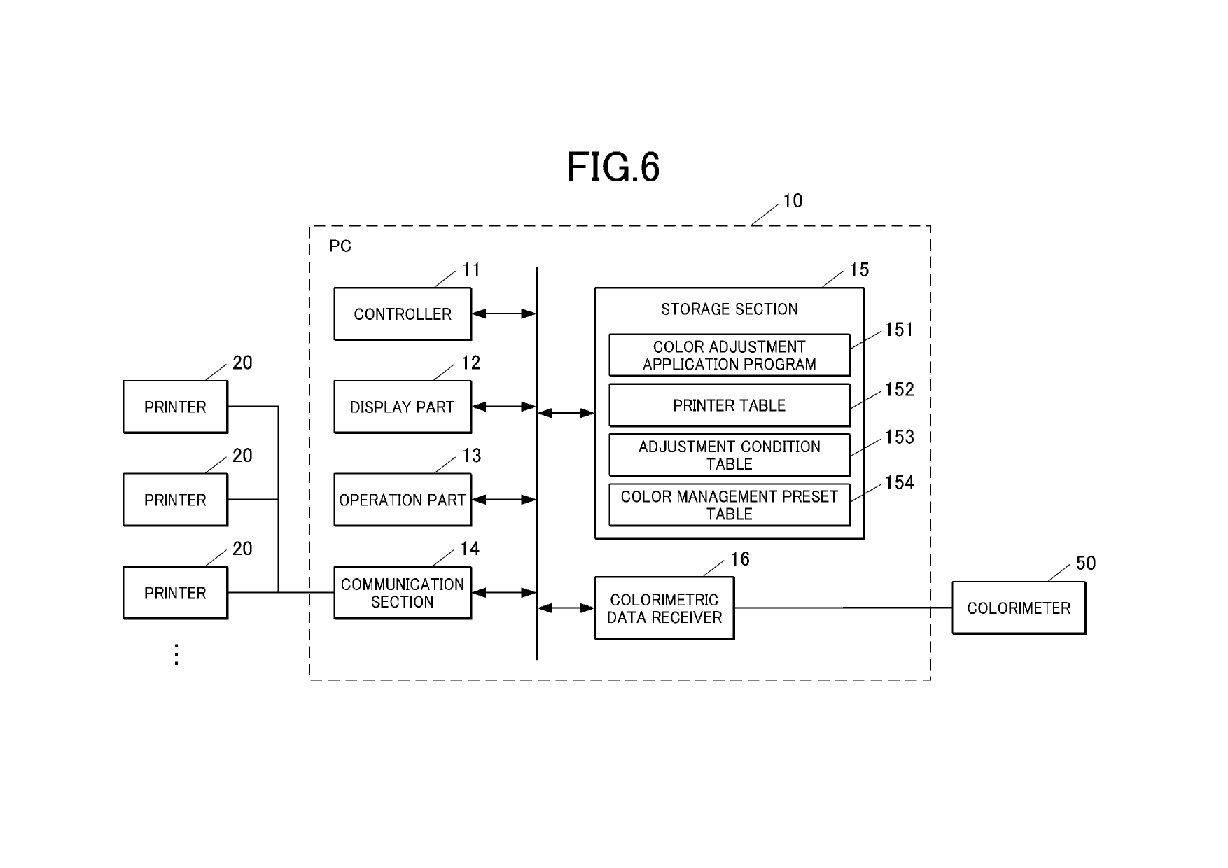

A color adjustment application program 151 (see FIG. 6) for performing color adjustment of the printers 20 is installed in the PC 10.

The printers 20 are each an image forming apparatus that forms an image on a sheet. Each of the plurality of printers 20 is a five color machine (a first image forming engine) or a four color machine (a second image forming engine). The four color machine is capable of image formation with color materials of four colors (CMYK four colors) of cyan (C), magenta (M), yellow (Y), and black (K). The five color machine is capable of image formation with four color materials of cyan, magenta, yellow, and black and the fifth color material other than the four color materials. In the present embodiment, each printer 20 is an electrophotographic image forming apparatus that uses toner as a color material. In the present embodiment, white (W) is used as the fifth color will be described, but the fifth color is not limited to white.

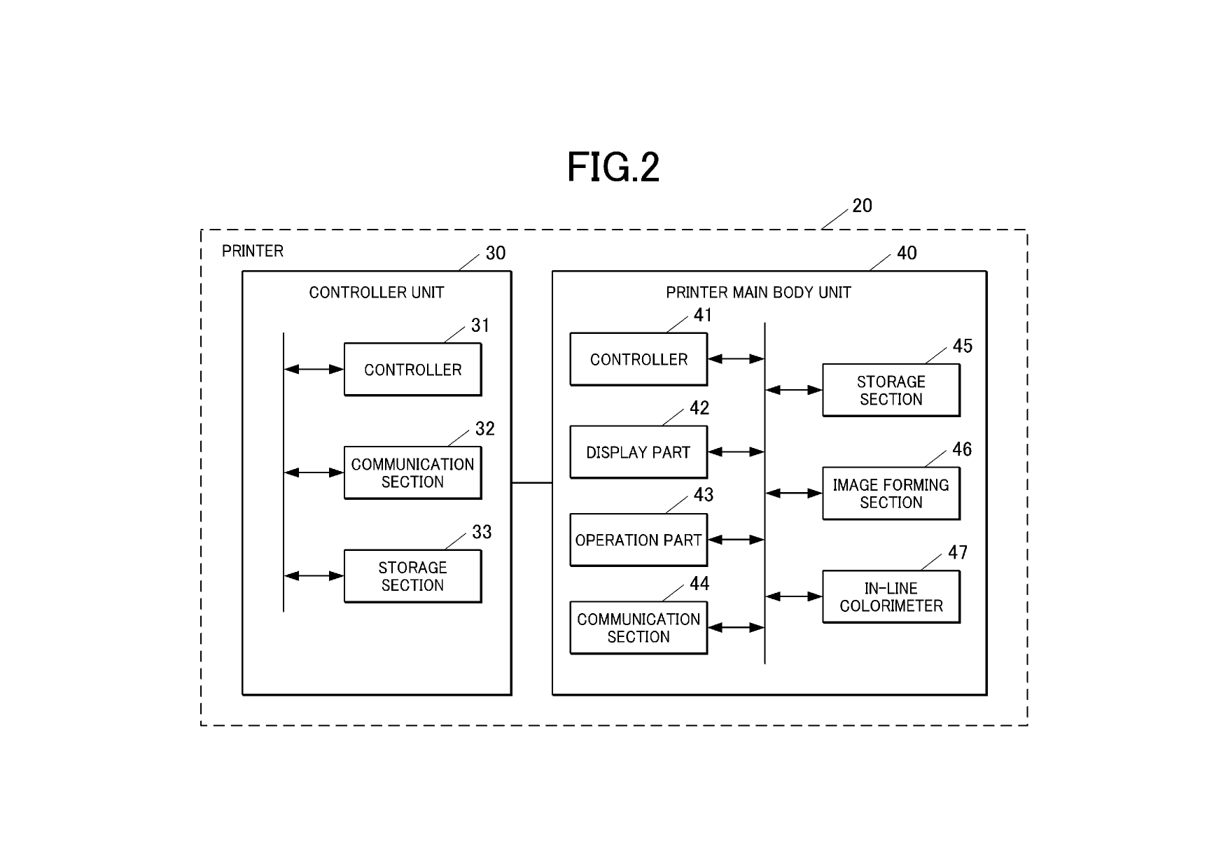

FIG. 2 shows a configuration of each printer 20. The printer 20 includes a controller unit 30 and a printer main body unit 40. The controller unit 30 performs raster image processing on a job received from the PC 10 or the like to generate raster data. The printer main body unit 40 forms an image on a sheet on the basis of the raster data.

The controller unit 30 includes a controller 31, a communication section 32, and a storage section 33.

The controller 31 performs various kinds of control on the components of the controller unit 30. The controller 31 includes a central processing unit (CPU), a random access memory (RAM), and the like. Specifically, the CPU reads various process programs stored in the storage section 33, and loads the programs into the RAM. The CPU performs various processes in cooperation with the programs. For example, the controller 31 converts print data into raster data.

The communication section 32 performs data communication with an external device. The communication section 32 receives a job (print data,etc) from an external device such as the PC 10. The communication section 32 sends raster data to the printer main body unit 40.

The storage section 33 includes a hard disk drive (HDD), a solid state drive (SSD), and a nonvolatile memory. The storage section 33 stores various process programs and various types of data such as parameters and files necessary for executing the programs. For example, the storage section 33 stores adjustment values (correction values) related to a function to adjust the color of the printer 20. The storage section 33 stores correction values such as an ICC profile and a tone curve. The ICC file is information defined by an international organization and indicates the color of a printer. The ICC file is used for color conversion. The tone curve adjustment is adjustment in an input/output density curve for each color used for image formation, and affects the color tone, brightness, contrast, and the like.

The printer main body unit 40 includes a controller 41, a display part 42, an operation part 43, a communication section 44, a storage section 45, and an image forming section 46.

The controller 41 performs various kinds of control on the components of the printer main body unit 40. The controller 41 includes a CPU, a RAM, and the like. Specifically, the CPU reads various programs stored in the storage section 45, and loads the programs into the RAM. The CPU performs various processes in cooperation with the programs.

The display part 42 is configured by a liquid crystal display (LCD). The display part 42 displays various screens in accordance with instructions of display signals input from the controller 41.

The operation part 43 receives various operations made by a user and outputs operation signals based on the operations to the controller 41.

The communication section 44 performs data communication with an external device. The communication section 44 receives a print instruction and the like from an external device such as the PC 10. The communication section 44 receives raster data from the controller unit 30.

The storage section 45 includes an HDD, an SSD, a nonvolatile memory, and the like. The storage section 45 stores various process programs and various types of data such as parameters and files necessary for executing the programs. Information on the operation of the printer main body unit 40 is stored in the storage section 45. For example, the storage section 45 stores sheet attribute information on the printer 20 and adjustment values (correction values) on functions for stabilizing the machine (image forming engine). The storage section 45 stores correction values for maximum density, density balance, calibration, and the like. The maximum density adjustment is adjustment in the density of a solid (for example, C = 100%) for each color used for image formation. The density balance adjustment is adjustment of in-plane unevenness. The calibration is adjustment related to gradation.

The image forming section 46 forms an image on a sheet by an electrophotographic method. The image forming section 46 includes photosensitive drums corresponding to the respective colors of toner used for image formation, an intermediate transfer belt, and a fixing section. The image forming section 46 uniformly charges a photosensitive drum corresponding to, for example, cyan, and then scans and exposes the photosensitive drum with a laser beam based on the image data of cyan to form an electrostatic latent image. The image forming section 46 develops the electrostatic latent image on the photosensitive drum corresponding to cyan by causing cyan toner to adhere to the electrostatic latent image. The same applies to the other colors. The image forming section 46 sequentially transfers the toner images of the respective colors formed on the photosensitive drums corresponding to the respective colors onto the intermediate transfer belt (primary transfer). That is, a color toner image in which the toner images of the colors are superimposed is formed on the intermediate transfer belt. The image forming section 46 collectively transfers the color toner image on the intermediate transfer belt onto a sheet (secondary transfer). The image forming section 46 causes the fixing section to fix the color toner image onto the sheet. The image forming section 46 may form an image of five colors using white toner in addition to CMYK toners, or may form an image of four colors using CMYK toners. The controller 41 causes the image forming section 46 to form an image based on raster data received from the controller unit 30.

The printer main body unit 40 may include an in-line colorimeter 47. The in-line colorimeter 47 is provided on a conveyance route of sheets after image formation. The in-line colorimeter 47 measures the color of a patch on a sheet being conveyed.

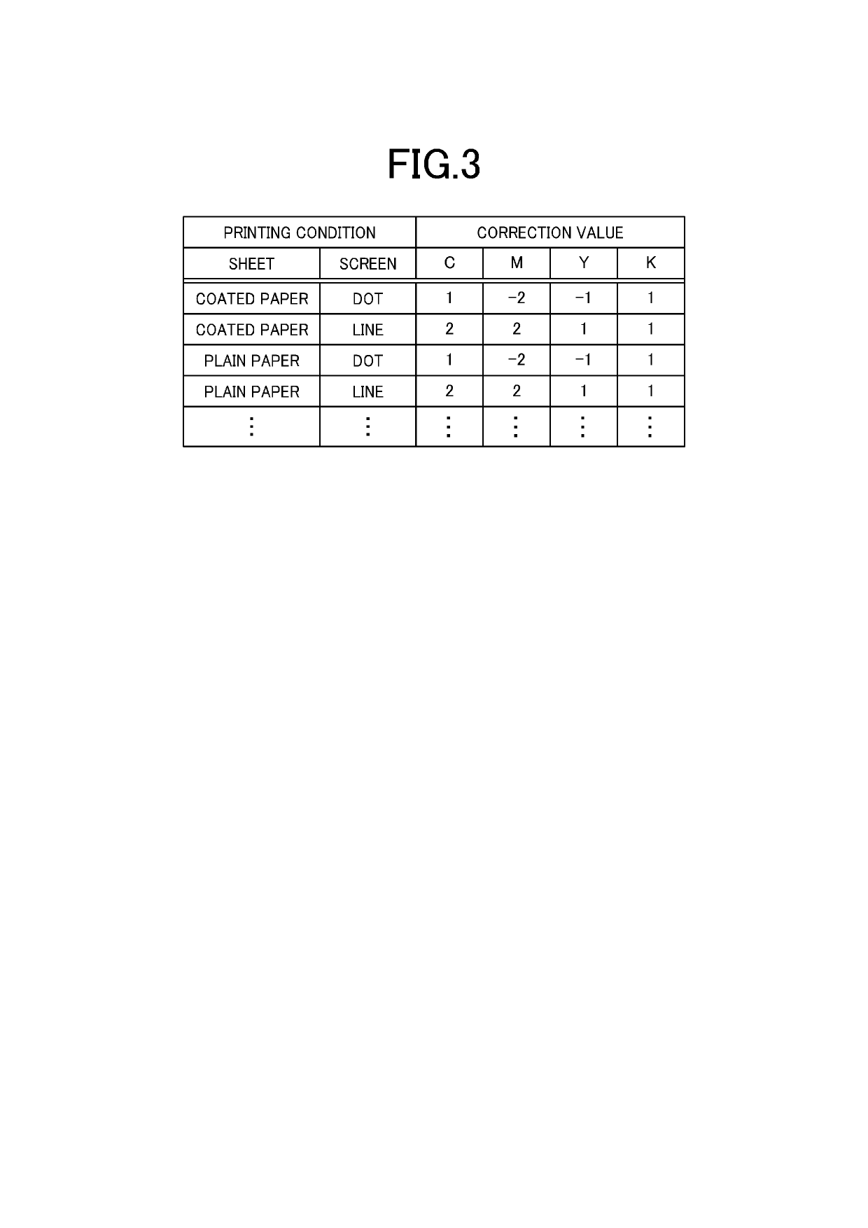

FIG. 3 shows examples of correction values held in the printer 20 (the controller unit 30 or the printer main body unit 40). In the printer 20, the maximum density, the tone curve, and the like are held for each combination of parameters such as a sheet and a screen. The printer 20 can output an image in an adjusted color at the time of printing by using correction values corresponding to printing conditions such as a sheet and a screen to be used. FIG. 3 shows examples of the correction values of the maximum density. The printer 20 performs color adjustment using the correction values of the row corresponding to the combination of the sheet (coated paper, plain paper, or the like) and the screen (dot, line, or the like) used by the user. The printing condition and the correction values are different for each color adjustment function. Although FIG. 3 shows examples of correction values in the four color machine, in the case of the five color machine, correction values for the fifth color (white, etc) are also included.

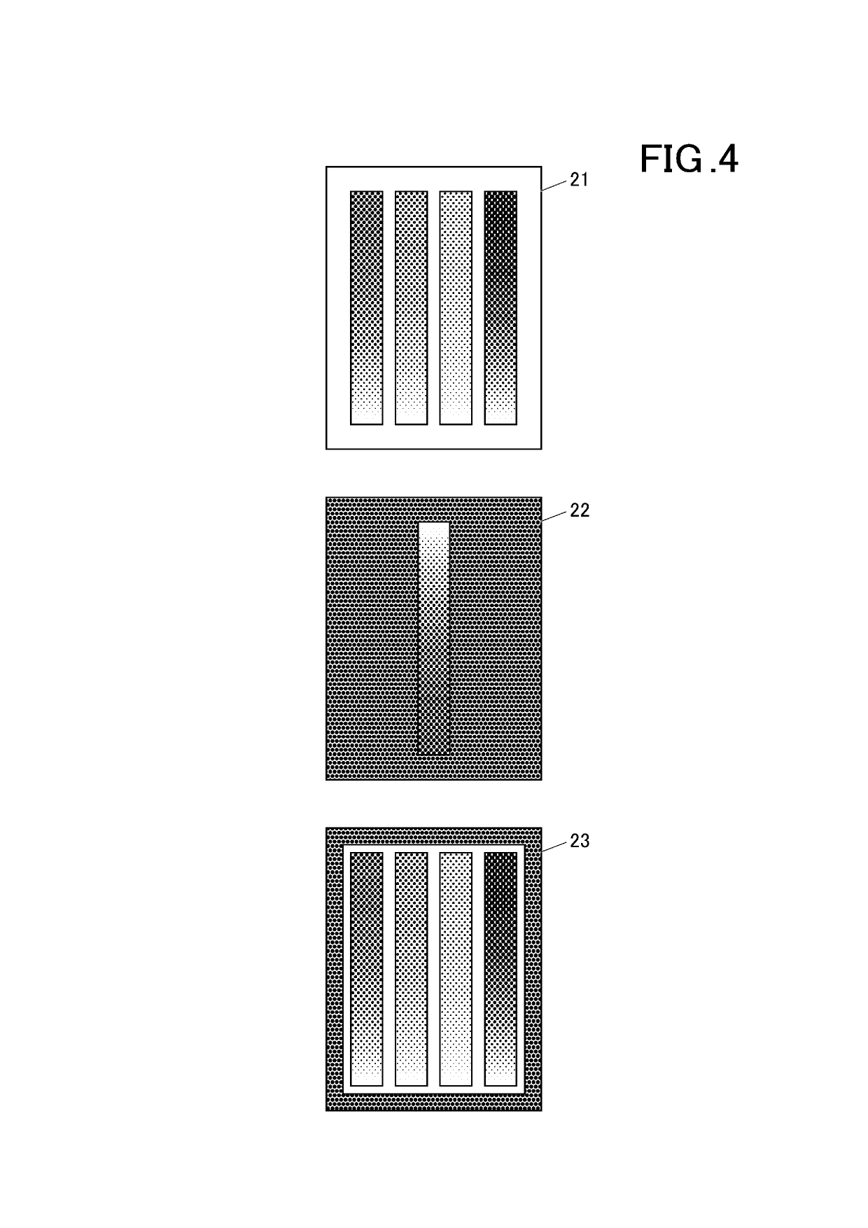

The printing mode in the printer 20 will be described with reference to FIG. 4.

In the case of printing with CMYK 4 colors, a CMYK printing mode 21 using the CMYK toners is selected.

Examples of the printing mode in which the white toner is used in the five color machine include a white printing mode 22 and a white undercoat printing mode 23. The white printing mode 22 is a mode in which printing is performed on a color sheet using only the white toner. The color sheet is a sheet other than a white sheet. The white undercoat printing mode 23 is a mode in which the entire surface of a color sheet is painted with the white toner, and printing is performed thereon with the CMYK toners.

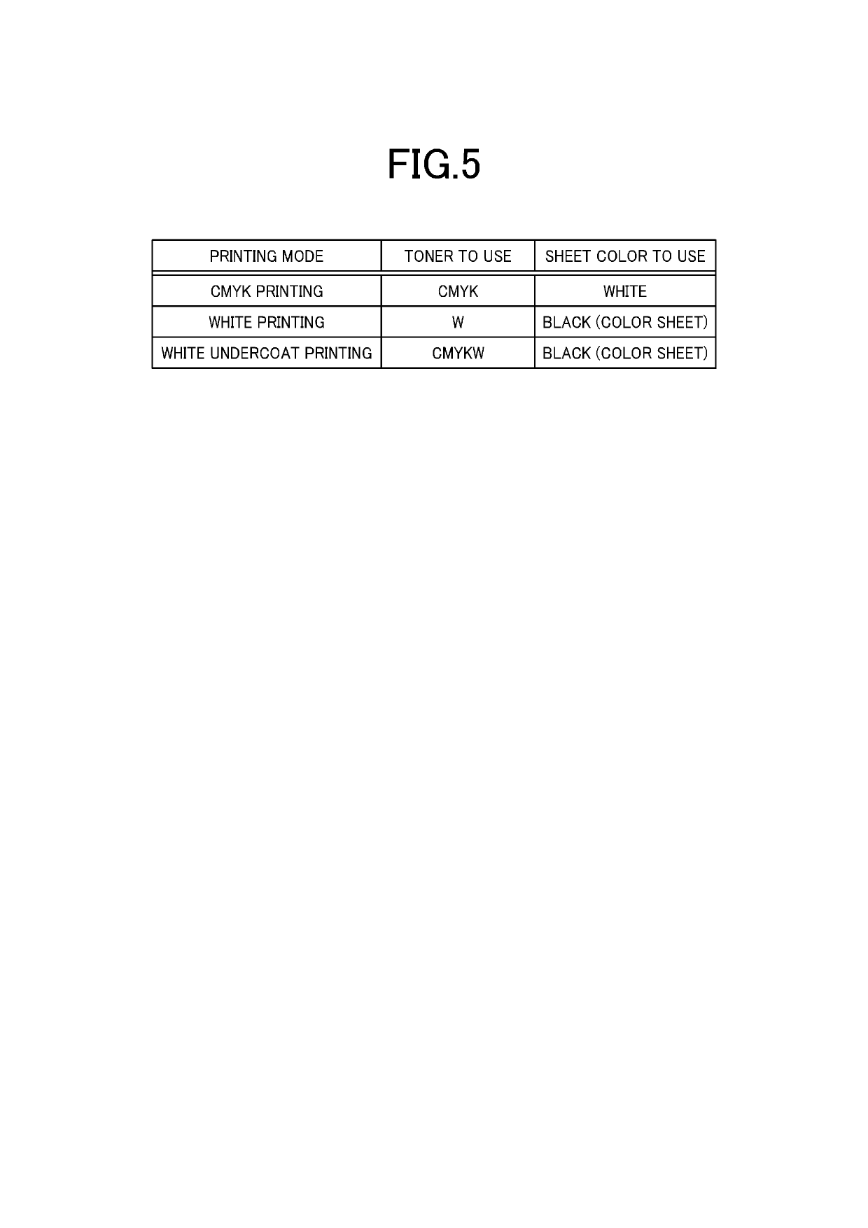

FIG. 5 shows a relationship between the toner to be used and the sheet color to be used in each printing mode. In the CMYK printing mode 21, color adjustment is performed using the CMYK toners with the white sheet as a reference. In the case of the fifth color machine including white toner (W), color adjustment cannot be performed on a white sheet in the white printing mode 22 or the white undercoat printing mode 23. Therefore, a colored sheet such as a black sheet is used in the printing mode that uses white toner, of the five color machine. The sheet color of the color sheet is not limited to black, and a sheet of a color desired by the user may be used.

FIG. 6 illustrates a configuration of the PC 10. The PC 10 includes a controller 11 (hardware processor), a display part 12, an operation part 13, a communication section 14, a storage section 15, and a colorimetric data receiver 16.

The controller 11 comprehensively controls the processing operation of each component of the PC 10. The controller 11 includes a CPU, a RAM, and the like. Specifically, the CPU reads various process programs stored in the storage section 15 and loads the programs into the RAM. The CPU performs various processes in cooperation with the programs.

The display part 12 includes a monitor such as an LCD. The display part 12 displays various screens in accordance with instructions of display signals input from the controller 11.

The operation part 13 includes a keyboard and a pointing device such as a mouse. The operation part 13 outputs the operation signals, which are input by key operations on the keyboard and operations on the pointing device, to the controller 11. In a case where the operation part 13 includes a touch screen laminated on the display part 12, the operation part 13 outputs operation signals corresponding to positions of touch operations with a finger of the operator or the like to the controller 11.

The communication section 14 is configured by a network interface or the like. The communication section 14 transmits and receives data to and from an external device such as the printer(s) 20 connected via the communication network N.

The storage section 15 includes an HDD, an SSD, a nonvolatile memory, and the like. The storage section 15 stores various process programs and various types of data such as parameters and files necessary for executing the programs. For example, the storage section 15 stores a color adjustment application program 151 and the like. A color adjustment application is implemented by cooperation of the controller 11 and the color adjustment application program 151. The color adjustment application provides a user interface for giving an execution instruction to each color adjustment function of the printer 20, confirming a color measurement result, calculating a correction value, and the like. The color adjustment application is connected to the plurality of printers 20 and an external colorimeter 50 through the communication network N. The color adjustment application obtains the correction values held in the printer 20 or sets correction values in the printer 20. The color adjustment application calculates correction values for color adjustment for each printer 20 and manages color adjustment of the plurality of printers 20. The color adjustment application guides the user in accordance with the order of steps in each color adjustment function. The storage section 15 stores data such as a chart to be used for color adjustment.

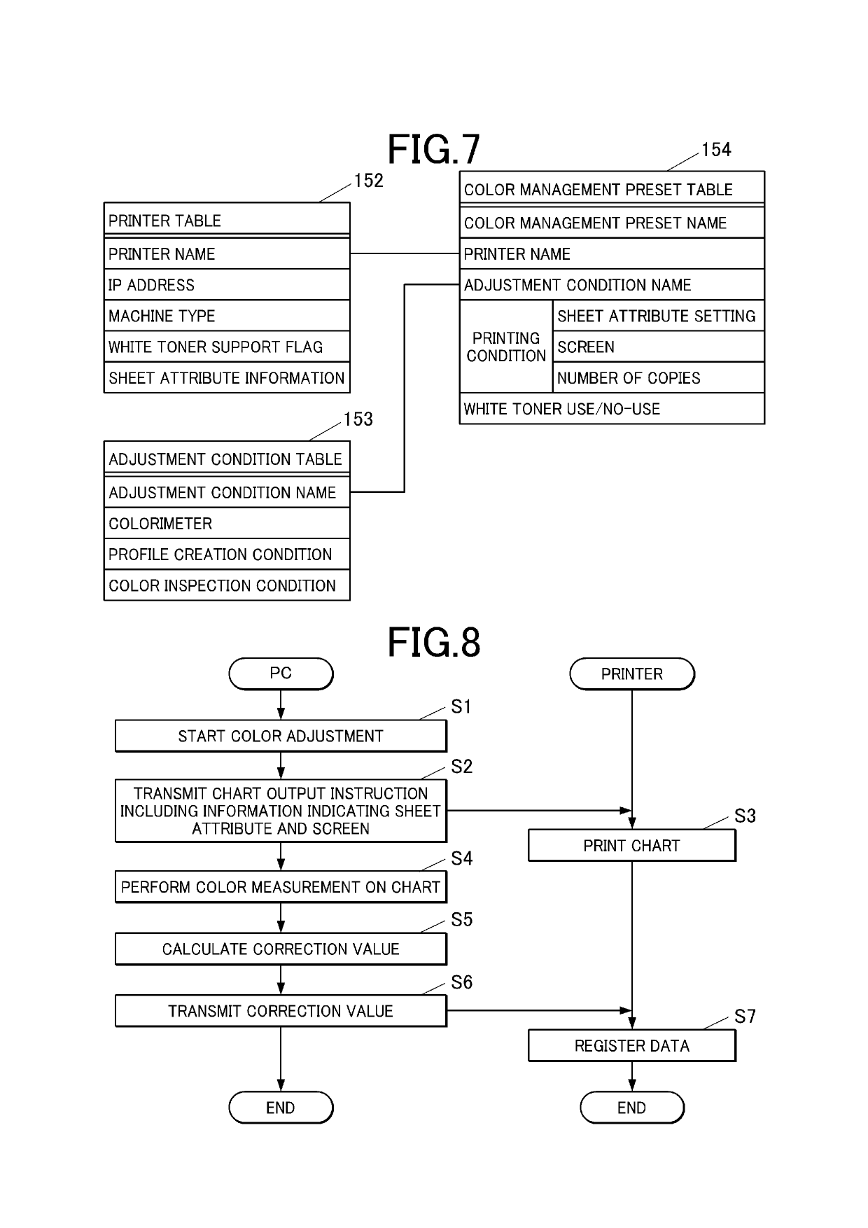

The storage section 15 stores a printer table 152, an adjustment condition table 153, and a color management preset table 154. FIG. 7 illustrates examples of data structures of the printer table 152, the adjustment condition table 153, and the color management preset table 154.

The printer table 152 is a table for managing printer information on the plurality of printers 20 in the color management system 100. In the printer table 152, a printer name, an IP address, a machine type, a white toner support flag, sheet attribute information, and the like are associated with each other for each printer 20.

The printer name is the name of the printer 20.

The IP address is an IP address of the printer 20 (the controller unit 30 and the printer main body unit 40).

The machine type is a machine type of the printer 20.

The white toner support flag is information indicating whether the printer 20 is a white toner support machine (five color machine). Specifically, in a case where the printer 20 is a white toner support machine, the white toner support flag is "ON". In a case where the printer 20 is not a white toner support machine, that is, in a case where the printer 20 is a four color machine, the white toner support flag is "OFF".

The sheet attribute information is information on a sheet(s) to be used in the printer 20. The sheet attribute information includes a sheet feed tray, a sheet profile, a sheet size, a sheet type, a basis weight, a sheet color, and the like.

The adjustment condition table 153 is a table for managing adjustment conditions used in the color adjustment application. The adjustment conditions may also be referred to as a target configuration (color management target setting). The adjustment conditions include conditions for performing color measurement or adjustment in color adjustment. Since the adjustment conditions are common even if the machine (printer) is changed, various settings are collectively registered. In the adjustment condition table 153, an adjustment condition name, a colorimeter, a profile creation condition, a color inspection condition, and the like are associated with each other for each adjustment condition.

The adjustment condition name is the name of the adjustment condition.

The colorimeter is information for specifying a colorimeter used for color measurement.

The profile creation condition is a condition for creating a profile.

The color inspection condition is a condition for performing color inspection. Examples of the color inspection condition include determination items and allowable values for color inspection.

The color management preset table 154 is a table for managing color management presets. The color management preset is a collection of adjustment contents in the printer 20 in order to simplify settings at the time of color adjustment. In the present embodiment, the color management preset is setting information including printer information, an adjustment condition, a printing condition, and white toner use/no-use. In the color management preset table 154, for each color management preset, a color management preset name, a printer name, an adjustment condition name, a printing condition, the white toner use/no-use, and the like are associated with each other.

The color management preset name is the name of a color management preset.

The printer name is the name of the printer 20 for the printer information included in the color management preset.

The adjustment condition name is the name of an adjustment condition included in the color management preset.

The printing condition includes a sheet attribute setting, a screen, the number of copies, and the like. The sheet attribute setting is a setting related to sheets, and include a sheet color, a basis weight, and the like in addition to a sheet type (coated paper, plain paper, or the like). The screen is a screen used for printing. The number of copies is the number of copies for when a chart is printed.

When the printer 20 is the five color machine, the color management preset includes the white toner use/no-use. In the color management preset, in a case where use of the white toner is set, the white toner use/no-use is "ON". In the color management preset, in a case where no-use of the white toner is set, the white toner use/no-use is "OFF". When the printer 20 is the four-color machine, the color management preset does not include the white toner use/no-use.

In the color management preset table 154, each color management preset is associated with printer information stored in the printer table 152 by a printer name. In the color management preset table 154, each color management preset is associated with an adjustment condition stored in the adjustment condition table 153 by an adjustment condition name.

The colorimetric data receiver 16 receives data on colorimetric values (L^{*}a^{*}b^{*} values, etc.) from the colorimeter 50. The colorimeter 50 is connected to the PC 10 via a USB (Universal Serial Bus) cable or the like. The colorimeter 50 measures colors of a patch group included in a chart printed by the printer 20 and outputs colorimetric values.

The controller 11 cooperates with the color adjustment application program 151 to manage color adjustment of the printers 20 connected via the network N. For example, the controller 11 performs color adjustment with respect to each of printing modes such as the CMYK printing mode 21, the white printing mode 22, and the white undercoat printing mode 23.

The controller 11 receives a selection of a color management preset (color adjustment setting) in which the white toner use/no-use (first color material setting) indicating whether to use white toner (color material of the fifth color) for image formation and a sheet attribute setting of a sheet to be used for image formation are associated with each other.

The controller 11 causes the printer 20 as the five color machine (first image forming engine) to perform color adjustment on the basis of the white toner use/no-use and the sheet attribute setting corresponding to the selected color management preset. Specifically, the controller 11 causes the printer 20 to perform color adjustment with respect to a printing mode corresponding to the white toner use/no-use included in the selected color management preset, using a sheet corresponding to the sheet attribute setting included in the selected color management preset.

As options of the color management preset (color adjustment setting), there is a plurality of color management presets. The plurality of color management presets include a first color adjustment setting and a second color adjustment setting. The first color adjustment setting is a color management preset in which no-use of the white toner for image formation is set as the white toner use/no-use, and a white sheet is set as the sheet attribute setting. The second color adjustment setting is a color management preset in which use of the white toner for image formation is set as the white toner use/no-use, and a sheet other than a white sheet is set as the sheet attribute setting.

When the second color adjustment setting is selected, the controller 11 receives a selection of the second color material setting indicating whether to perform color adjustment with only the white toner (color material of the fifth color) or with the CMYK toners (color materials of the four colors) and the white toner.

The controller 11 causes the printer 20 as the five color machine (first image forming engine) to perform color adjustment on the basis of the selected second color material setting.

When performing color adjustment with only the white toner is selected as the second color material setting, the controller 11 selects the adjustment chart (first adjustment chart) for white printing corresponding to the white toner. The controller 11 causes the printer 20 as the five color machine (first image forming engine) to perform color adjustment using the selected adjustment chart for white printing.

When performing color adjustment with the CMYK toners and the white toner is selected as the second color material setting, the controller 11 selects the adjustment chart (second adjustment chart) for white undercoat printing corresponding to the CMYK toners and the white toner. The controller 11 causes the printer 20 as the five color machine (first image forming engine) to perform color adjustment using the selected adjustment chart for white undercoat printing.

The controller 11 receives a registration(s) of the first color adjustment setting and the second color adjustment setting as the color management preset (color adjustment setting). That is, the controller 11 receives a registration of the color management preset (first color adjustment setting) in which no-use of the white toner for image formation is set as the white toner use/no-use and a white sheet is set as the sheet attribute setting. Further, the controller 11 receives a registration of the color management preset (second color adjustment setting) in which use of the white toner for image formation is set as the white toner use/no-use and a sheet other than a white sheet is set as the sheet attribute setting.

When registering the second color adjustment setting as the color management preset (color adjustment setting), the controller 11 receives a setting of an image formation parameter(s) for white toner (color material of the fifth color). For example, when registering the second color adjustment setting, the controller 11 receives a screen setting for the white toner.

In a case where the registration of the color management preset (color adjustment setting) for the printer 20 as the four color machine (second image forming engine) is received, the controller 11 prohibits the reception of the setting of using the white toner (color material of the fifth color) for the image formation as the white toner use/no-use (first color material setting).

### Operation in Color Management System

Next, operation in the color management system 100 will be described.

First, an outline of a color adjustment process will be described with reference to FIG. 8. Here, a case where the maximum density is adjusted will be described as an example.

The controller 11 of the PC 10 activates the color adjustment application in response to an operation from the operation part 13 by the user. The user selects a printer 20 to be subjected to color adjustment and a color adjustment function (maximum density).

The controller 11 starts color adjustment (Step S1). The controller 11 transmits an instruction to output a chart to the printer 20 as the color adjustment target via the communication section 14 (Step S2). The output instruction for the chart includes information indicating the sheet attribute of the sheet as the color adjustment target and a screen. Further, the chart relating to the output instruction includes a plurality of patches using the toner(s) of the color adjustment target(s).

In the printer 20, the controller 41 of the printer main body unit 40 receives the output instruction for the chart via the communication section 44. The controller 41 causes the image forming section 46 to print the chart (Step S3). The controller 41 controls the image forming section 46 to print each patch using the toner as the color adjustment target on the sheet as the color adjustment target. Note that the print instruction for the chart may be transmitted from the PC 10 to the printer main body unit 40 via the controller unit 30.

The user performs color measurement of each patch of the chart with the colorimeter 50 connected to the PC 10. The controller 11 obtains a colorimetric value corresponding to each patch of the chart from the colorimeter 50 via the colorimetric data receiver 16 (Step S4). Note that the color measurement of the chart may be performed by the in-line colorimeter 47 included in the printer main body unit 40. In this case, the controller 11 obtains the colorimetric value corresponding to each patch of the chart from the printer main body unit 40 via the communication section 14.

Next, the controller 11 calculates a correction value for color adjustment (maximum density) based on the colorimetric value (Step S5). Specifically, the controller 11 calculates the correction value based on the difference between the colorimetric value and the target. The controller 11 transmits the calculated correction value to the printer 20 via the communication section 14 (Step S6).

The controller 41 of the printer main body unit 40 receives the correction value via the communication section 44 and registers the received correction value in the storage section 45 (Step S7). Thereafter, the controller 41 adjusts the maximum density using the correction value.

Even in color adjustment other than that in the maximum density adjustment, the printer 20 prints a chart including a patch for color adjustment on a sheet as the color adjustment target. The controller 11 obtains the colorimetric value corresponding to each patch and registers, in the printer 20, the correction value calculated from the difference between the colorimetric value and the target.

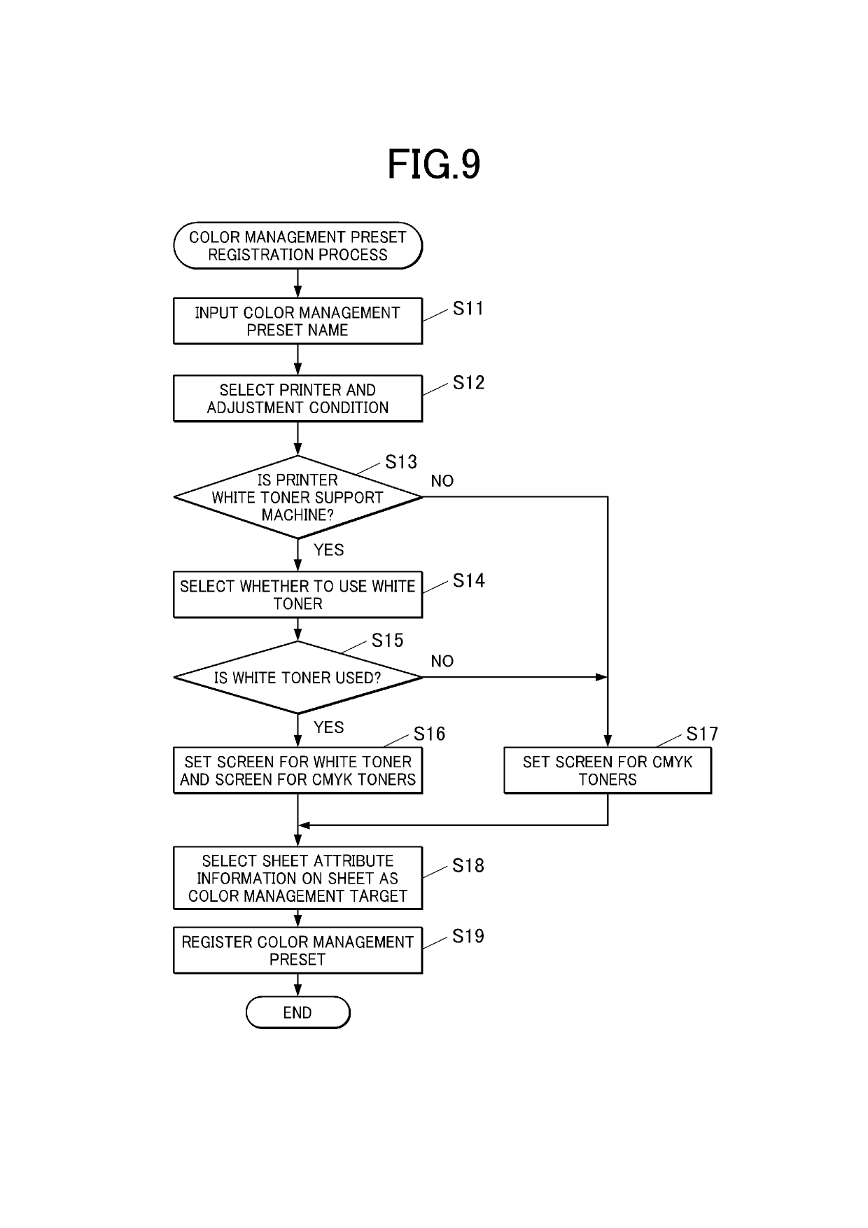

Next, a color management preset registration process that is executed at the PC 10 will be described with reference to FIG. 9. This process is implemented by software processing by the CPU of the controller 11 in cooperation with the color adjustment application program 151.

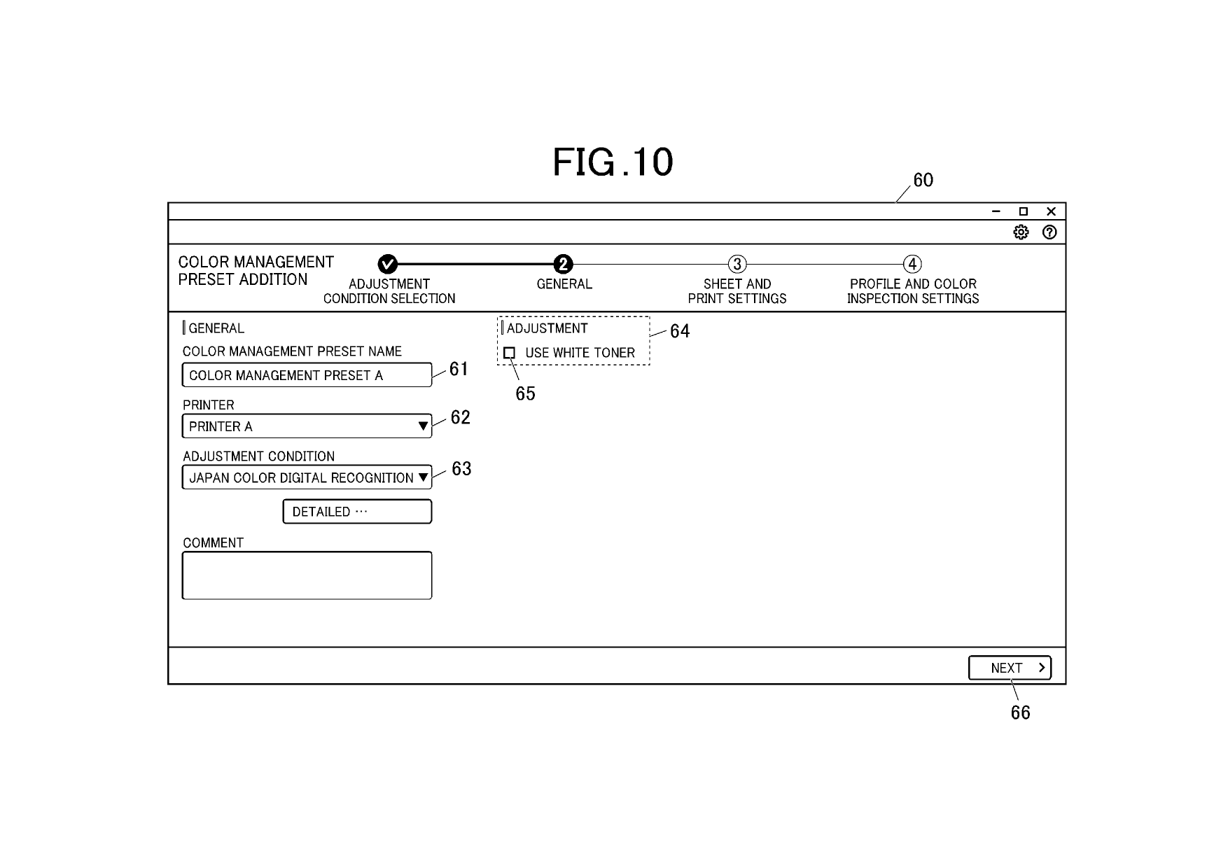

When the user selects the registration of the color management preset from the menu screen by the operation from the operation part 13, the controller 11 causes the display part 12 to display a color management preset setting screen 60 shown in FIG. 10. The color management preset setting screen 60 includes a color management preset name input field 61, a printer selection field 62, an adjustment condition selection field 63, and a next button 66.

The color management preset name input field 61 is an area for inputting the name of a color management preset to be newly registered (color management preset name).

The printer selection field 62 is an area for selecting one of the printers 20 registered in the printer table 152.

The adjustment condition selection field 63 is an area for selecting an adjustment condition from adjustment conditions (target configurations) registered in the adjustment condition table 153.

The user inputs a color management preset name in the color management preset name input field 61 by an operation from the operation part 13. The controller 11 receives input of a color management preset name (Step S11).

The user selects one of the printers 20 as a color management target in the printer selection field 62 by an operation from the operation part 13. The controller 11 receives a selection of a printer 20 (Step S12).

The user selects one of the adjustment conditions in the adjustment condition selection field 63 by an operation from the operation part 13. The controller 11 receives a selection of an adjustment condition (Step S12).

The controller 11 determines whether the selected printer 20 is a white toner support machine (Step S13). Specifically, the controller 11 determines, with reference to the printer table 152, whether the white toner support flag corresponding to the selected printer 20 is ON.

If the selected printer 20 is a white toner support machine (Step S13; YES), the controller 11 prompts the user to select whether to use white toner (Step S14). Specifically, the controller 11 causes the color management preset setting screen 60 illustrated in FIG. 10 to display the setting field 64 indicating whether to use the white toner. The setting field 64 of whether to use the white toner includes a checkbox 65 for selecting whether or not to use the white toner.

The controller 11 determines whether use of the white toner has been selected (Step S15). When the user checks the checkbox 65 by an operation from the operation part 13, the controller 11 determines that the use of the white toner has been selected.

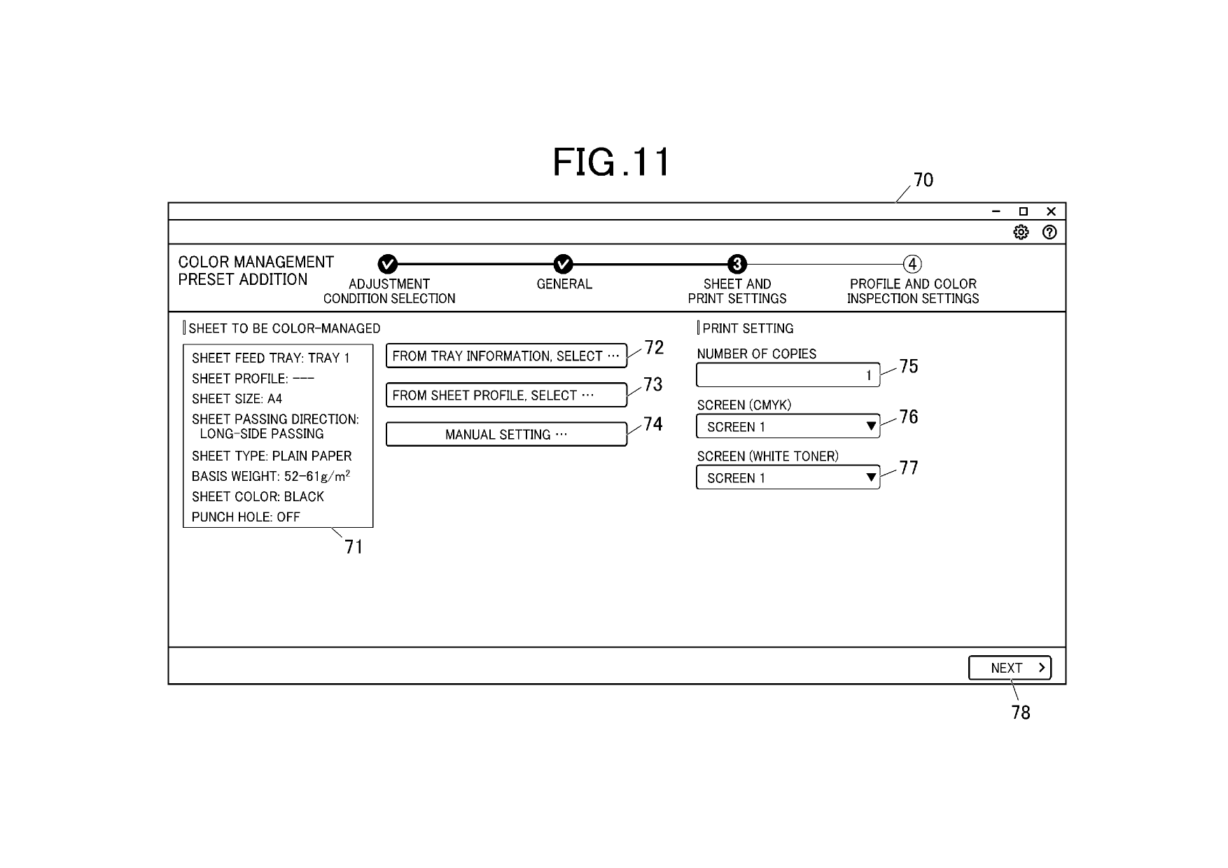

If the use of the white toner has been selected (Step S15; YES), the controller 11 receives settings of the screen for the white toner and the screen for the CMYK toners (Step S16). Specifically, when the next button 66 is pressed in a state where the checkbox 65 is checked on the color management preset setting screen 60, the controller 11 causes the display part 12 to display a sheet-and-print setting screen 70 shown in FIG. 11. The sheet-and-print setting screen 70 includes a sheet attribute information display field 71, a tray selection button 72, a sheet profile selection button 73, a manual setting button 74, a number-of-copies input field 75, a CMYK screen selection field 76, a W screen selection field 77, a next button 78, and the like.

The sheet attribute information on the sheet to be subjected to color management is displayed in the sheet attribute information display field 71.

When the tray selection button 72 is pressed, the controller 11 obtains, for each sheet feed tray of the printer 20 selected in the printer selection field 62, the sheet attribute information associated with the sheet feed tray from the printer table 152. The controller 11 causes the sheet attribute information associated with the sheet feed tray selected by the user to be displayed in the sheet attribute information display field 71.

When the sheet profile selection button 73 is pressed, the controller 11 obtains, for each sheet profile of the printer 20 selected in the printer selection filed 62, the sheet attribute information associated with the sheet profile from the printer table 152. The controller 11 causes the sheet attribute information associated with the sheet profile selected by the user to be displayed in the sheet attribute information display field 71.

When the manual setting button 74 is pressed, the controller 11 causes the display part 12 to display a sheet attribute information setting screen. The user sets the sheet attribute information on the sheet as the color management target by selecting various pieces of information for items in the setting screen. The controller 11 causes the sheet attribute information set by the user to be displayed in the sheet attribute information display field 71.

The number-of-copies input field 75 is an area for inputting the number of copies to be printed of a chart.

The CMYK screen selection field 76 is an area for selecting a screen for CMYK toners. The user selects a screen for the CMYK toners in the CMYK screen selection field 76 by an operation from the operation part 13.

The W screen selection field 77 is an area for selecting a screen for the white toner. The user selects a screen for the white toner in the W screen selection field 77 by an operation from the operation part 13.

In Step S13, if the selected printer 20 is not a white toner support machine (Step S13; NO), the controller 11 does not display the setting field 64 of whether to use the white toner on the color management preset setting screen 60 illustrated in FIG. 10. When the next button 66 is pressed on the color management preset setting screen 60 in which the setting field 64 of whether to use the white toner is not displayed, the controller 11 receives a setting of a screen for the CMYK toners (Step S17). The controller 11 does not cause the W screen selection field 77 to be displayed on the sheet-and-print setting screen 70 illustrated in FIG. 11.

If use of the white toner is not selected in Step S15 (Step S15; NO), the controller 11 receives a setting of a screen for the CMYK toners (Step S17). Specifically, on the color management preset setting screen 60 illustrated in FIG. 10, the next button 66 is pressed with the checkbox 65 unchecked. In that case, the controller 11 does not cause the W screen selection field 77 to be displayed on the sheet-and-print setting screen 70 illustrated in FIG. 11.

After Step S16 or Step S17, the controller 11 receives a selection of sheet attribute information on a sheet to be subjected to color management (color management target) (Step S18). The user presses any one of the tray selection button 72, the sheet profile selection button 73, and the manual setting button 74 on the sheet-and-print setting screen 70 shown in FIG. 11 to set the sheet attribute information on the sheet to be subjected to color management. For example, the user sets the color or the like of the sheet to be subjected to color management.

On the sheet-and-print setting screen 70, when the next button 78 is pressed after various settings are made, the controller 11 registers the color management preset (Step S19). Specifically, the controller 11 stores, in the color management preset table 154, the color management preset name, the printer's name, the adjustment condition name, the printing condition (sheet attribute setting, screen, number of copies, and the like), and the white toner use/no-use in association with each other. The sheet attribute setting includes a sheet type (coated paper, plain paper, or the like), a sheet color, and the like. Note that the white toner use/no-use is registered only for the five-color machine.

Thus, the color management preset registration process ends.

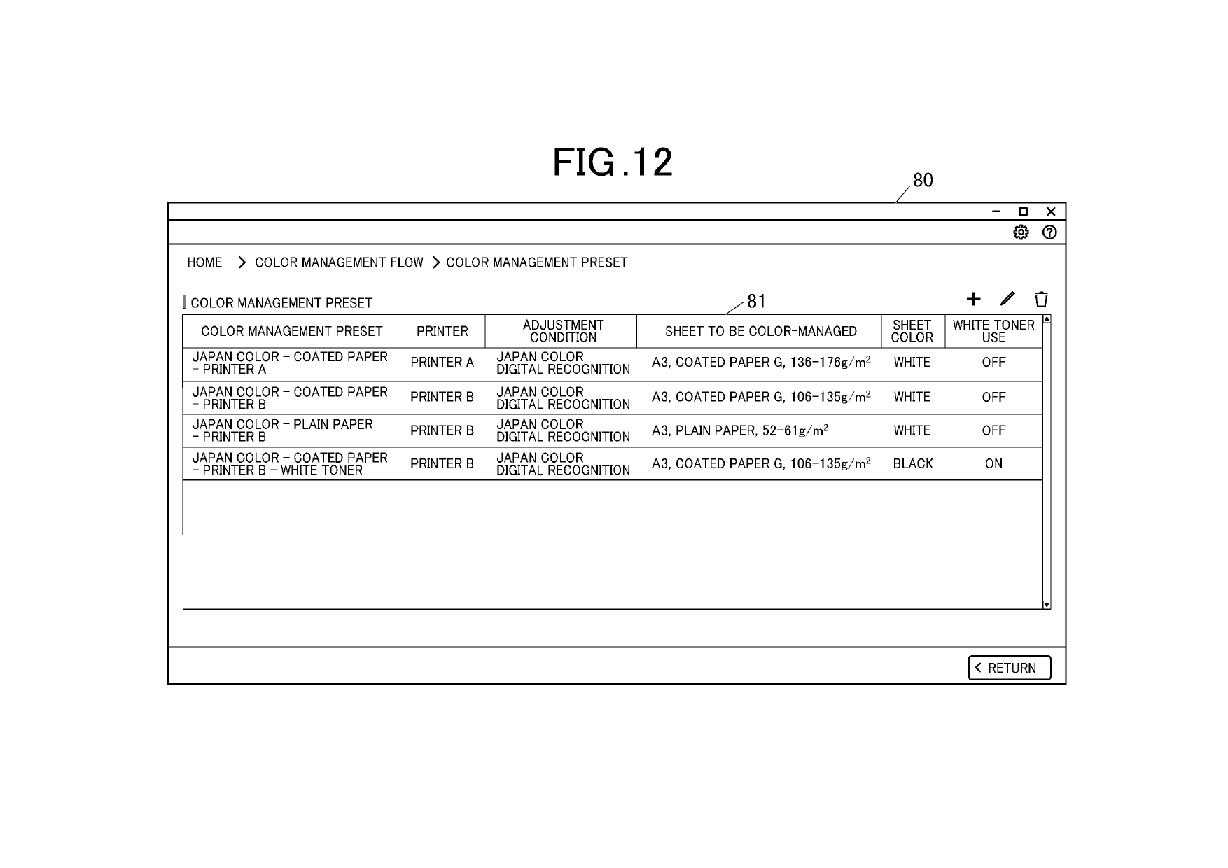

FIG. 12 illustrates an example of a color management preset list screen 80 displayed on the display part 12. The color management preset list screen 80 includes a color management preset list field 81. In the color management preset list field 81, for each registered color management preset, pieces of information such as a color management preset name, a printer, an adjustment condition, a sheet for color management, a sheet color, and use of white toner are displayed in an associated manner. In the "white toner use" field, whether use of the white toner is set (ON/OFF) in the corresponding color management preset is displayed. The ON/OFF of the "white toner use" field is displayed only for the five color machine.

Note that in the color management preset registration process, when the printer 20 is the four color machine, the controller 11 does not display the setting field 64 of whether to use the white toner on the color management preset setting screen 60. Instead of this, the controller 11 may display the setting field 64 of whether to use the white toner in a gray-out state to prohibit a setting of whether to use the white toner, for example.

When the printer 20 is the four color machine or when use of white toner is not selected in the printer 20 as the five color machine, the controller 11 does not display the W screen selection field 77 on the sheet-and-print setting screen 70. Instead of this, the controller 11 may display the W screen selection field 77 in a gray-out state to prohibit the setting of the screen for the white toner, for example.

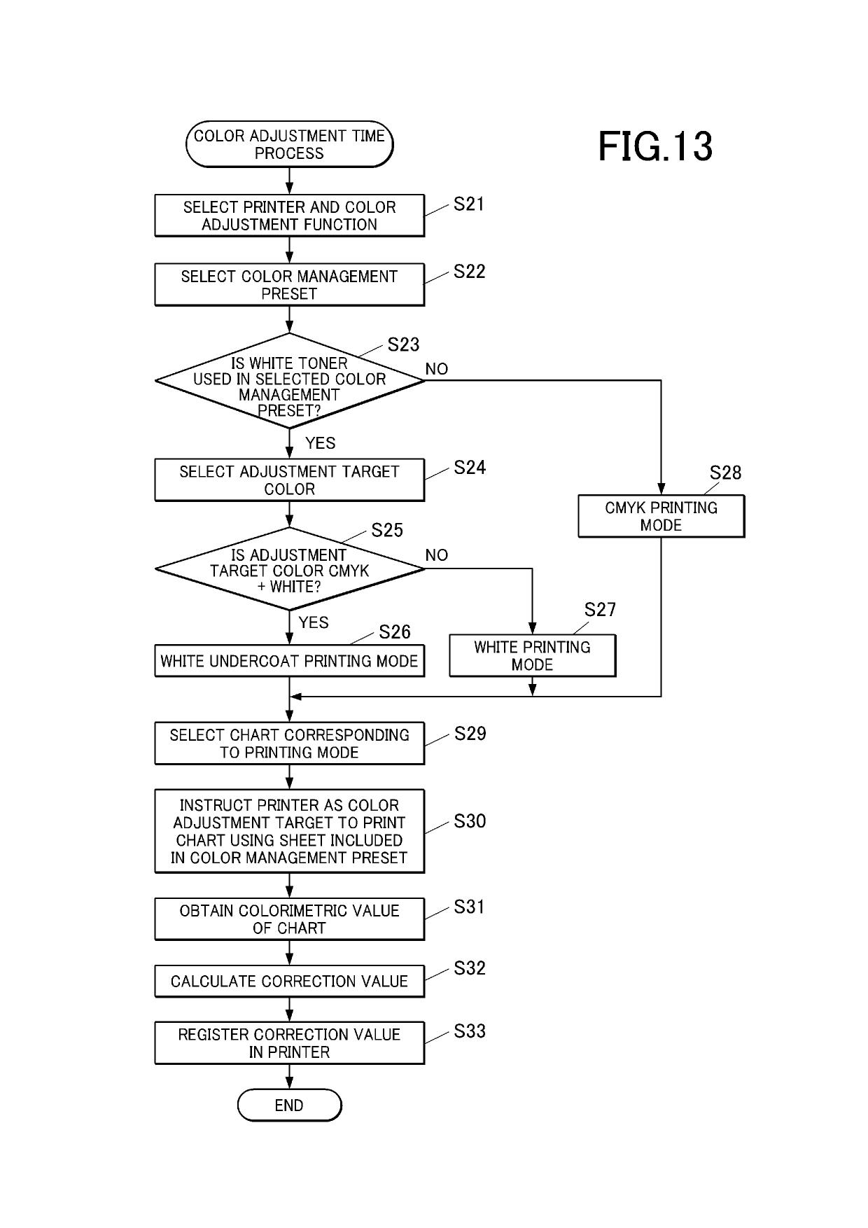

Next, a color adjustment time process that is executed at the PC 10 will be described with reference to FIG. 13. This process is implemented by software processing by the CPU of the controller 11 in cooperation with the color adjustment application program 151.

First, the controller 11 receives a selection of a printer 20 which is a color adjustment target and a selection of a color adjustment function (Step S21). Examples of the color adjustment function include maximum density adjustment, density balance adjustment, calibration, and profile creation. An adjustment screen for a calibration function to correct gradation will be described below as an example.

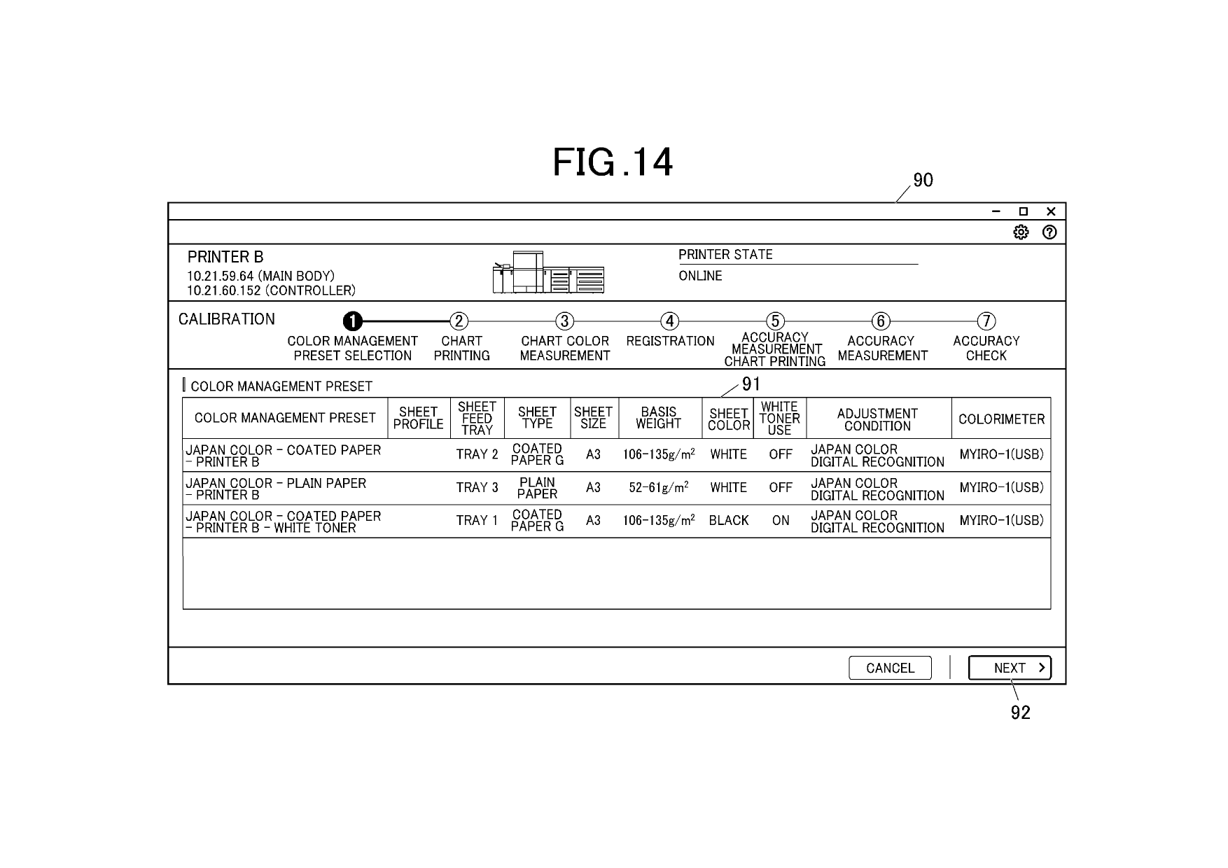

The controller 11 causes the display part 12 to display a color management preset selection screen 90 illustrated in FIG. 14. The color management preset selection screen 90 includes a color management preset list field 91, a next button 92, and the like. The controller 11 refers to the color management preset table 154 and extracts a color management preset(s) that includes the printer 20 that is the color adjustment target. The controller 11 causes information on the extracted color management preset(s) to be displayed in the color management preset list field 91. In the color management preset list field 91, main setting contents included in the color management preset are displayed. The "white toner use" field is displayed only when the printer 20 selected as the color adjustment target is the five color machine. In the "white toner use" field, whether use of the white toner is set (ON/OFF) in the corresponding color management preset is displayed.

The user selects one of the color management presets in the color management preset list field 91 by an operation from the operation part 13. The controller 11 receives a selection of a color management preset (Step S22). On the color management preset selection screen 90, when the next button 92 is pressed, the process proceeds to Step S23.

The controller 11 determines whether use of the white toner is set in the selected color management preset (Step S23). Specifically, the controller 11 refers to the "white toner use/no-use" of the color management preset table 154 for the selected color management preset and determines whether use of white toner for image formation is set. For example, when the white toner use/no-use in the color management preset table 154 is "ON", the controller 11 determines that the use of the white toner is set. When the white toner use/no-use in the color management preset table 154 is "OFF", the controller 11 determines that the use of the white toner is not set. If in the color management preset table 154, the record corresponding to the selected color management preset does not include the white toner use/no-use, the controller 11 determines that the use of the white toner is not set.

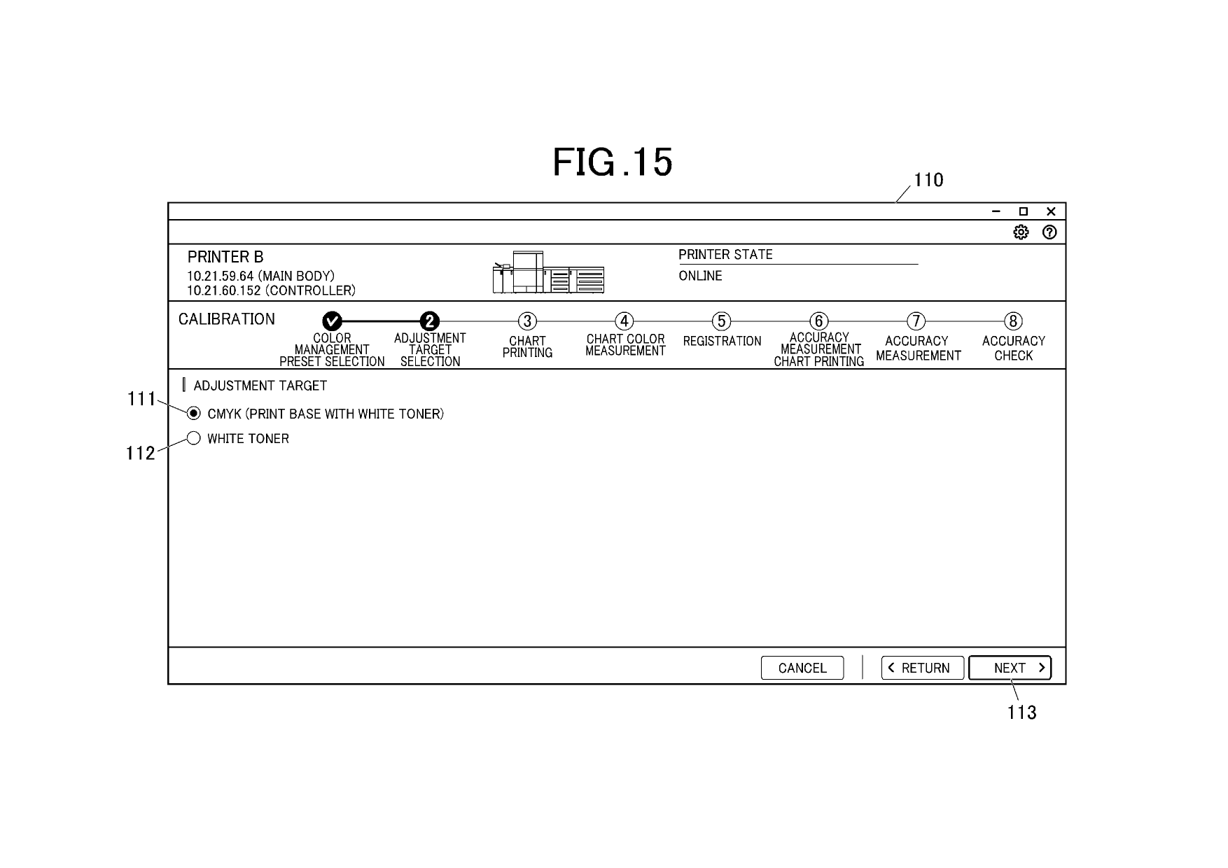

If the use of the white toner is set in the selected color management preset (Step S23; YES), the controller 11 receives a selection of the adjustment target color (Step S24). Specifically, the controller 11 causes the display part 12 to display an adjustment target color selection screen 110 illustrated in FIG. 15. The adjustment target color selection screen 110 includes radio button 111 and 112 for selecting the adjustment target color to be adjusted and a next button 113. The radio button 111 is selected when CMYK four colors and white are the colors to be adjusted. That is, when the radio button 111 is selected, adjustment of the white undercoat printing is performed. The radio button 112 is selected when only white is the color to be adjusted. That is, when the radio button 112 is selected, adjustment of the white printing is performed. The user selects one of the radio buttons 111 and 112. When the next button 113 is pressed on the adjustment target color selection screen 110, the process proceeds to Step S25.

The controller 11 determines whether the adjustment target color is CMYK and white (Step S25). Specifically, the controller 11 determines whether the radio button 111 is selected or the radio button 112 is selected on the adjustment target color selection screen 110.

When the adjustment target color is CMYK and white (Step S25; YES), the controller 11 selects the white undercoat printing mode 23 (Step S26).

In Step S25, when the adjustment target color is not CMYK and white (Step S25; NO), that is, when the adjustment target color is only white, the controller 11 selects the white printing mode 22 (Step S27).

In Step S23, when the use of the white toner is not set in the selected color management preset (Step S23; NO), the controller 11 selects the CMYK printing mode 21 (Step S28).

In Step S26, Step S27, or Step S28, a printing mode is automatically selected. When the user selects a color management preset (color adjustment target sheet) in the color management preset list field 91 of the color management preset selection screen 90, it is determined whether the color adjustment target printing mode is the CMYK printing mode 21 or the white-included printing modes. In the case of the white-included printing modes, when the user selects the adjustment target color, it is determined whether the color adjustment target printing mode is the white undercoat printing mode 23 or the white printing mode 22.

After Step S26, Step S27, or Step S28, the controller 11 selects a chart corresponding to the printing mode (Step S29). The chart is prepared for each color adjustment function and for each printing mode. The controller 11 may change the arrangement of the patches on the chart according to the sheet attribute setting of the printing condition included in the selected color management preset. The controller 11 may change the arrangement of the patches on the chart according to the colorimeter of the adjustment condition included in the selected color management preset.

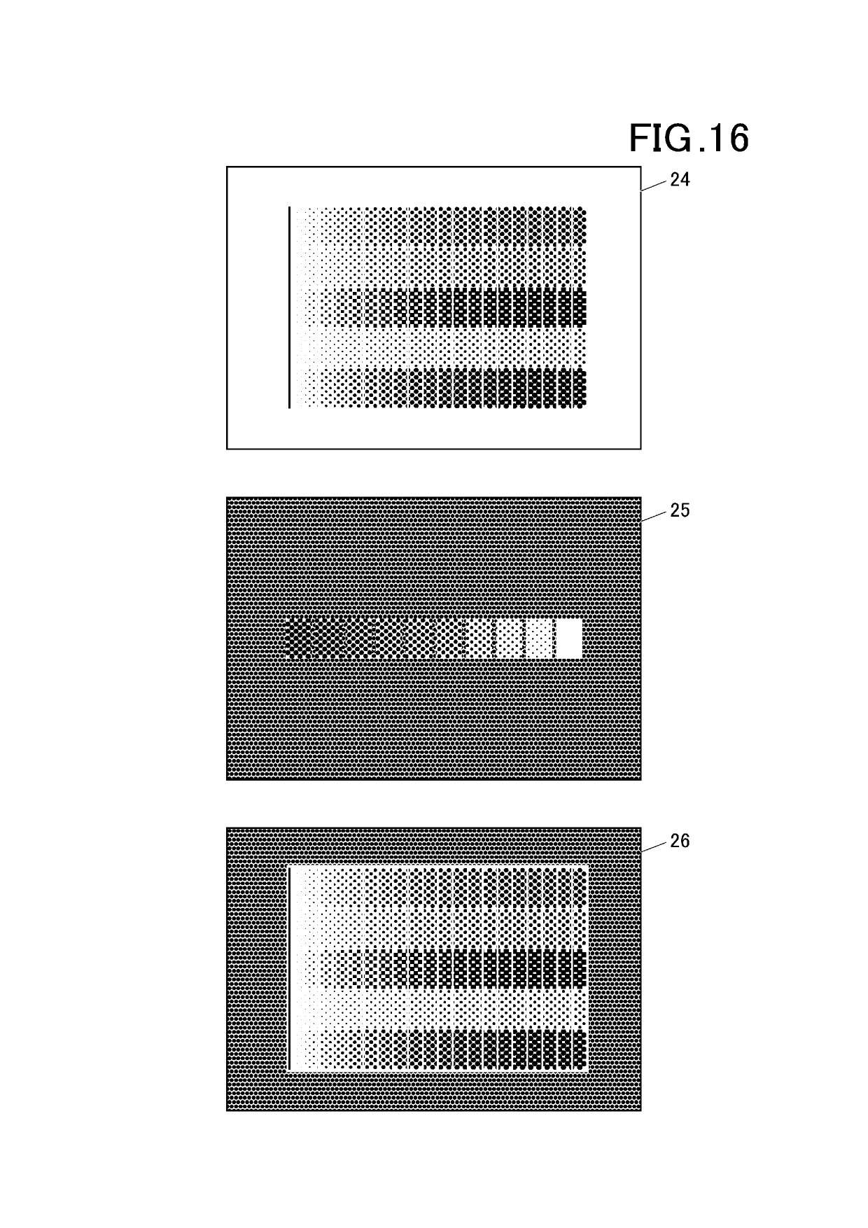

FIG. 16 illustrates examples of a chart used for color adjustment (calibration).

When adjustment is performed for CMYK printing, an adjustment chart 24 for CMYK printing is used. The adjustment chart 24 for CMYK printing is a chart in which patches showing gradations of CMYK are printed on a white sheet or the like.

When adjustment is performed for white printing, an adjustment chart 25 for white printing is used. The adjustment chart 25 for white printing is a chart in which patches showing gradations of white are printed on a color sheet such as a black sheet.

When adjustment is performed for white undercoat printing, an adjustment chart 26 for white undercoat printing is used. The adjustment chart 26 for white undercoat printing is a chart in which a white base is formed on a color sheet such as a black sheet, and patches showing gradations of CMYK are printed thereon.

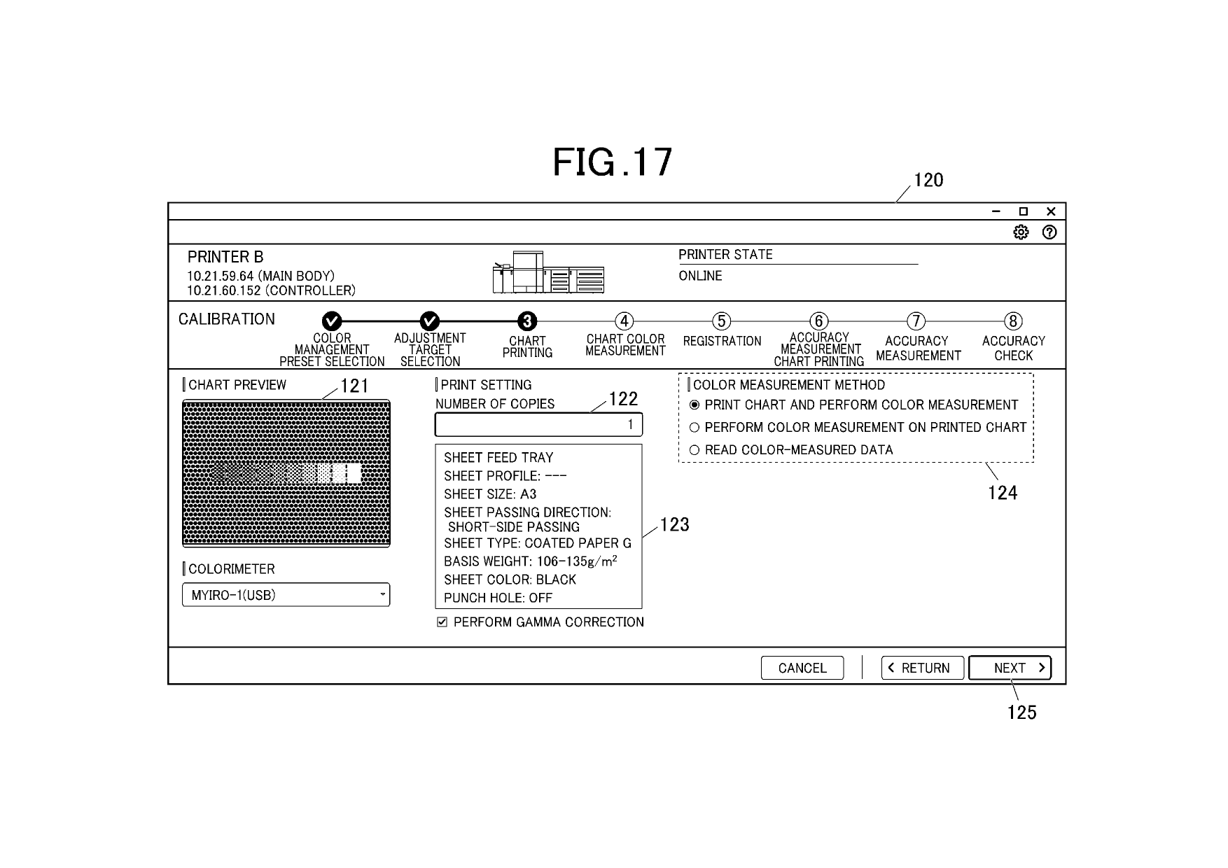

After Step S29, the controller 11 causes the display part 12 to display a chart printing screen 120 illustrated in FIG. 17. The chart printing screen 120 includes a chart preview field 121, a number-of-copies input field 122, a sheet attribute information display field 123, a color measurement method selection field 124, a next button 125, and the like.

In the chart preview field 121, a chart selected in accordance with the printing mode is preview-displayed. In the chart preview field 121, one of the adjustment chart 24 for CMYK printing, the adjustment chart 25 for white printing, and the adjustment chart 26 for white undercoat printing is displayed. Thus, when the user selects a color management preset from among color management presets registered in advance, a chart to be used is automatically selected. Note that whether the adjustment chart 25 for white printing or the adjustment chart 26 for white undercoat printing is selected depends on the result of the selection in Step S24.

The number of copies on which a chart is printed in calibration is displayed in the number-of-copies input field 122.

The sheet attribute information on the sheet on which the chart is printed is displayed in the sheet attribute information display field 123.

In the color measurement method selection field 124, whether to print a chart and perform color measurement, to perform color measurement on a printed chart, or to read color-measured data is selected. Here, it is assumed that "print a chart and perform color measurement" is selected.

On the chart printing screen 120, when the next button 125 is pressed, the controller 11 instructs the printer 20 as the color adjustment target to print the chart using the sheet included in the color management preset (Step S30). This chart is a chart automatically selected in accordance with the printing mode. The print instruction of the chart to be transmitted to the printer 20 includes information indicating the sheet attribute of the sheet to be subjected to color adjustment and the screen.

Specifically, the controller 11 transmits the print instruction of the chart to the controller unit 30 of the printer 20 as the color adjustment target via the communication section 14. Based on the screen specified in the color management preset, the controller 31 of the controller unit 30 generates raster data for printing the chart. The controller 31 transmits the print instruction of the chart for calibration to the main body section 40 of the printer 20 as the color adjustment target via the communication section 32. The print instruction of the chart to be transmitted to the printer main body unit 40 includes raster data and information indicating the sheet attribute. The controller 41 of the printer main body unit 40 controls the image forming section 46 to print the chart for calibration on the sheet specified in the color management preset. Note that in a case where in the color measurement method selection field 124 color measurement on a printed chart is selected, or in reading of color-measured data is selected, chart printing is not performed.

Color measurement of each patch on the chart is performed with the colorimeter 50.

The controller 11 obtains the colorimetric value of the chart from the colorimeter 50 via the colorimetric data receiver 16 (Step S31).

The controller 11 calculates a correction value based on the colorimetric value of the chart (Step S32). Specifically, the controller 11 calculates the correction value based on the difference between the colorimetric value and the target. The controller 11 causes the display part 12 to display an adjustment result screen in accordance with the printing mode. When adjustment of CMYK (CMYK printing mode 21, white undercoat printing mode 23) is performed, the controller 11 causes only the adjustment result of the CMYK four colors to be displayed. When adjustment of the white toner is performed (white printing mode 22), the controller 11 causes the adjustment result of only the white toner to be displayed.

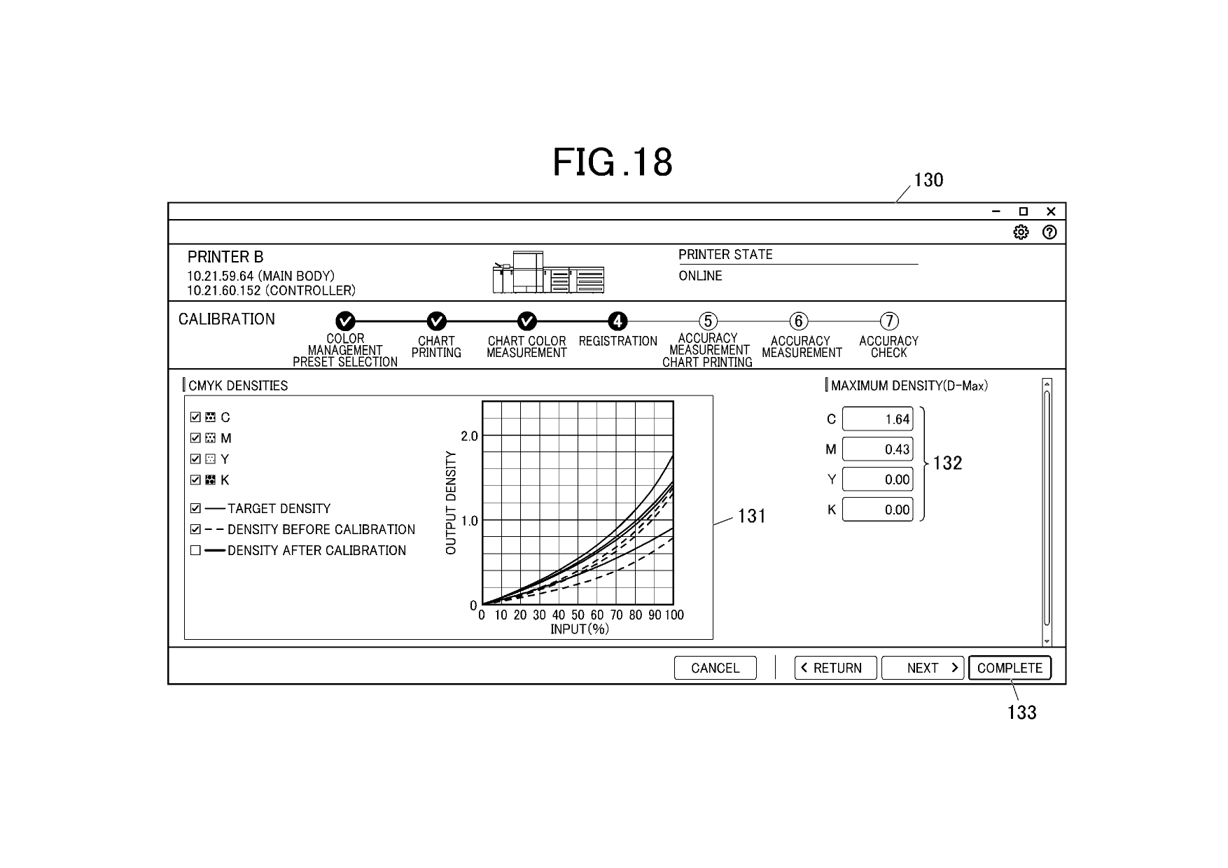

FIG. 18 illustrates an example of an adjustment result screen 130 in calibration in the CMYK printing mode 21 and the white undercoat printing mode 23. On the adjustment result screen 130, an output density graph display field 131, a maximum density display field 132, a complete button 133, and the like are displayed.

In the output density graph display field 131, a graph of output density with respect to input is displayed for each of the colors of CMYK. In the output density graph display field 131, it is possible to switch whether to display the graph about each of the target density, the density before calibration, and the density after calibration.

In the maximum density display field 132, the maximum density for each of the colors of CMYK is displayed.

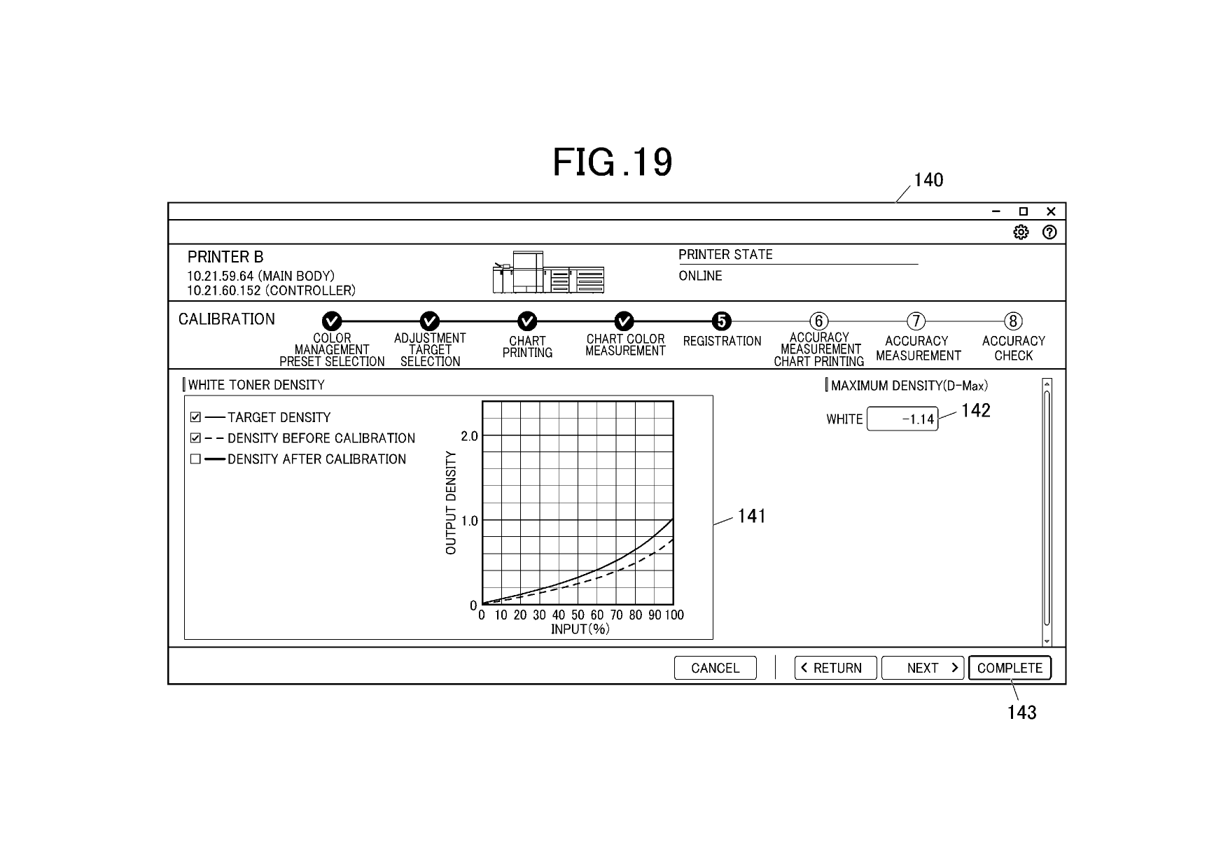

FIG. 19 illustrates an example of an adjustment result screen 140 in calibration in the white printing mode 22. In the adjustment result screen 140, an output density graph display field 141, a maximum density display field 142, a complete button 143, and the like are displayed.

In the output density graph display field 141, a graph of output density with respect to input is displayed for the white toner. In the output density graph display field 141, it is possible to switch whether to display the graph about each of the target density, the density before calibration, and the density after calibration.

In the maximum density display field 142, the maximum density for the white toner is displayed.

The user presses the complete button 133 on the adjustment result screen 130 or the complete button 143 on the adjustment result screen 140 to instruct completion of the calibration.

The controller 11 registers the correction value in the printer 20 as the color adjustment target (Step S33). The controller 11 sends the correction value to the printer 20 via the communication section 14. In the printer 20, upon receiving the correction value from the PC 10 via the communication section 32, the controller 31 of the controller unit 30 sends the correction value to the printer main body unit 40 via the communication section 32. When the controller 41 of the printer main body unit 40 receives the correction value from the controller unit 30 via the communication section 44, the controller 41 stores the correction value in the storage section 45. Note that the correction value may be directly transmitted from the PC 10 to the printer main body unit 40.

Thus, the color adjustment processing ends.

As described above, according to the present embodiment, the controller 11 of the PC 10 receives selection of a color management preset (color adjustment setting) in which the white toner use/no-use (first color material setting) and the sheet attribute setting are associated with each other. The controller 11 causes the printer 20 as the five color machine (first image forming engine) to perform color adjustment on the basis of the white toner use/no-use and the sheet attribute setting corresponding to the selected color management preset. Thus, the controller 11 can provide even an operator who has little experience in color adjustment with execution of color adjustment that does not require an advanced skill. The controller 11 can provide execution of efficient color adjustment without forcing the user to perform a complicated setting operation.

For example, when the first color adjustment setting is selected, the controller 11 can cause the printer 20 to perform color adjustment using a white sheet without using the white toner (color material of the fifth color).

When the second color adjustment setting is selected, the controller 11 can cause the printer 20 to perform color adjustment using the white toner and using a sheet other than a white sheet.

Thus, the user selecting a color management preset makes it unnecessary for the user to set whether to use the white toner, to set the sheet color, and the like with awareness.

Further, when the second color adjustment setting is selected, the controller 11 receives a selection of the second color material setting, which indicates whether to perform color adjustment with only the white toner or with the CMYK toners (color materials of the four colors) and the white toner. The controller 11 causes the printer 20 as the five color machine to perform color adjustment on the basis of the selected second color material setting. Thus, the controller 11 can provide execution of color adjustment suitable for the adjustment target color.

For example, when performing color adjustment with only the white toner is selected as the second color material setting, the controller 11 can cause the printer 20 to perform color adjustment using the adjustment chart 25 for white printing (first adjustment chart).

When performing the color adjustment with the CMYK toners and the white toner is selected as the second color material setting, the controller 11 can cause the printer 20 to perform color adjustment using the adjustment chart 26 for white undercoat printing (second adjustment chart) .

Thus, the controller 11 can select an adjustment chart corresponding to the selected second color material setting.

Further, the controller 11 receives a registration of the first color adjustment setting and the second color adjustment setting as the color management preset (color adjustment setting). When registering the color management preset, the controller 11 sets whether to use the white toner and the sheet attribute setting (sheet color, etc.) in association with each other. Thus, the controller 11 can register in advance the color management preset selected by the user.

When registering the second color adjustment setting as the color management preset, the controller 11 receives a setting of image formation parameters for the white toner (color material of the fifth color). For example, the controller 11 can easily obtain information necessary for image formation using the white toner by receiving a setting of a screen for the white toner.

In a case where the registration of the color management preset (color adjustment setting) for the printer 20 as the four color machine (second image forming engine) is received, the controller 11 prohibits the reception of the setting of using the white toner (color material of the fifth color) for the image formation as the white toner use/no-use (first color material setting). To be specific, the controller 11 allows the user to select the use or no-use of the white toner only when the printer 20 selected as the color management target is the white toner support machine in Step S13 of the color management preset registration process (see FIG. 9). On the other hand, when the printer 20 selected as the color management target is not the white toner support machine, the controller 11 does not cause the setting field 64 indicating whether to use the white toner to be displayed on the color management preset setting screen 60 illustrated in FIG. 10. The controller 11 can shorten the processing time and prevent a setting error by prohibiting unnecessary settings for the printer 20 which does not support the white toner.

Note that the description in the above embodiment is an example of the color adjustment management method, the color adjustment management apparatus, and the program according to the present disclosure, and the present disclosure is not limited to this. The detailed configuration and detailed operation of each component constituting the apparatus can also be appropriately changed without departing from the scope of the present disclosure.

For example, each process performed by the controller 11 (color adjustment application) of the PC 10 in the above embodiment may be performed by another apparatus provided in the color management system 100 or an apparatus connectable to the color management system 100. Further, each process performed by the controller 11 (color adjustment application) of the PC 10 may be performed by a plurality of apparatuses in cooperation with each other.

In the above embodiment, the setting screen on which setting items are sequentially selected in a wizard format in the color adjustment application has been exemplified. Alternatively, a setting screen on which various settings are included in one screen may be provided.

Although the case where toners are used as color materials in the electrophotographic printer 20 has been described in the above embodiment, this is no limitation. The color materials used for image formation by the printer 20 may be other materials such as ink.

In the above embodiment, the color adjustment application program 151 is locally installed in the PC 10. Alternatively, a color adjustment application on the cloud in the form of a SaaS (Software as a Service) type service can be used from the PC 10 via a browser.

Further, the various data (printer information, adjustment conditions, color management presets, and the like) stored in the storage section 15 of the PC 10 may be stored in an external apparatus or the like as ling as they can be used by the controller 11.

The computer-readable medium that stores the program for executing each process is not limited to the above-described example. Also, a carrier wave may be applied as a medium that provides data of the program via a communication line.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A color adjustment management method of managing color adjustment of a first image forming engine capable of forming an image with, in addition to color materials of four colors of cyan, magenta, yellow and black, a color material of a fifth color different from the color materials of the four colors, the color adjustment management method comprising:
receiving a selection of a color adjustment setting in which a first color material setting indicating whether to use the color material of the fifth color for image formation and a sheet attribute setting of a sheet to be used for image formation are associated with each other; and
causing the first image forming engine to perform color adjustment based on the first color material setting and the sheet attribute setting corresponding to the selected color adjustment setting.

2. The color adjustment management method according to claim 1,
wherein as options of the color adjustment setting, multiple color adjustment settings are present, and
wherein the color adjustment settings include:
a first color adjustment setting in which no-use of the color material of the fifth color for image formation is set as the first color material setting, and a white sheet is set as the sheet attribute setting; and
a second color adjustment setting in which use of the color material of the fifth color for image formation is set as the first color material setting, and a sheet other than a white sheet is set as the sheet attribute setting.

3. The color adjustment management method according to claim 2, comprising:
in response to the second color adjustment setting being selected, receiving a selection of a second color material setting indicating whether to perform color adjustment with only the color material of the fifth color or with the color materials of the four colors and the color material of the fifth color; and
causing the first image forming engine to perform color adjustment based on the selected second color material setting.

4. The color adjustment management method according to claim 3, comprising:
in response to performing color adjustment with only the color material of the fifth color being selected as the second color material setting, selecting a first adjustment chart corresponding to the color material of the fifth color and causing the first image forming engine to perform color adjustment using the first adjustment chart; and
in response to performing color adjustment with the color materials of the four colors and the color material of the fifth color being selected as the second color material setting, selecting a second adjustment chart corresponding to the color materials of the four colors and the color material of the fifth color and causing the first image forming engine to perform color adjustment using the second adjustment chart.

5. The color adjustment management method according to claim 2, comprising receiving a registration of, as the color adjustment setting, the first color adjustment setting and the second color adjustment setting.

6. The color adjustment management method according to claim 5, comprising, in response to the second color adjustment setting being registered as the color adjustment setting, receiving a setting of an image forming parameter for the color material of the fifth color.

7. The color adjustment management method according to claim 5,
wherein in addition to the first image forming engine, color adjustment of a second image forming engine capable of forming an image with the color materials of the four colors is performable, and
wherein the color adjustment management method comprises, in response to a registration of a color adjustment setting for the second image forming engine being received, prohibiting reception of a setting of using the color material of the fifth color for image formation as the first color material setting.

8. A color adjustment management apparatus comprising a hardware processor that performs the color adjustment management method according to claim 1.

9. A non-transitory computer-readable storage medium storing a program causing a computer that controls a color adjustment management apparatus to perform the color adjustment management method according to claim 1.
